(19) United States
(12) Patent Application Publication
(10) Pub. No.: US 2018/0031836 A1
(43) Pub. Date: Feb. 1, 2018

(54) SMART GLASSES HAVING INTERFERING LIGHT FILTERING

(71) Applicant: Caterpillar Inc., Peoria, IL (US)

(72) Inventors: Lonny Eric Johnson, Peoria, IL (US); Mark Michael Sheehan, Germantown Hills, IL (US); Jacob Carl Wyss, Eureka, IL (US)

(21) Appl. No.: 15/220,649

(22) Filed: Jul. 27, 2016

(51) Int. Cl. G02B 27/01; G02B 27/28

(52) U.S. Cl. CPC G02B 27/0172; G02B 27/281; G02B 27/0176; G02B 2027/0134; G02B 2027/0178; G02B 2027/0156

(57) ABSTRACT

A pair of smart glasses having interfering light filtering includes a glasses frame defining a horizontal view path and a semi-transparent display supported on the glasses frame and positioned in the horizontal view path. A projection mechanism is supported on the glasses frame and has a projection lens positioned above the horizontal view path. The projection mechanism is configured for projecting virtual content on the semi-transparent display, with an outer surface of the projection lens facing a rear facing surface of the semi-transparent display. A semi-transparent polarized shield is supported on the glasses frame and is positioned below the horizontal view path, with an inner surface of the semi-transparent polarized shield facing the outer surface of the projection lens. The semi-transparent polarized shield positioned to filter interfering light passing through the semi-transparent polarized shield and toward the projection lens.

### TECHNICAL FIELD

The present disclosure relates generally to a pair of smart glasses, and more particularly to smart glasses having interfering light filtering.

### BACKGROUND

Smart glasses are a relatively new technology and are essentially a wearable computer that adds environment and/or data to what the wearer of the smart glasses is viewing. Oftentimes the smart glasses are similar to other glasses, but also include or support a transparent heads-up display and/or an augmented reality overlay, both of which include the capability of reflecting projected digital images while still permitting the user to see through the display. Modern smart glasses may also include the capability of running self-contained applications and may operate using voice commands or touch buttons.

For example, U.S. Patent Application Publication No. 2015/0286055 to Giartosio et al. discloses a pair of augmented reality glasses created as closely as possible to mimic traditional glasses. The augmented reality glasses include a frame that supports a glasses lens, with part of the lens being an adaptive lens. The frame is associated with a miniaturized display configured for emitting images away from a plane comprising the longitudinal extension of the glasses lens. An optical system receives images from the display and processes the image. Reflection means are configured for receiving the processed images and reflecting them at a first predefined angle towards the glasses lens to project the processed image onto the glasses lens. The lens is made to reflect the image so that the center of the image is at the center of the glass lens and is reflected along the ocular axis, enabling the eye to perceive it at the center of the observed scene.

As should be appreciated, there is a continuing need to provide improved smart glasses and a method for improving the wearer's experience.

### SUMMARY OF THE INVENTION

In one aspect, a pair of smart glasses having interfering light filtering includes a glasses frame defining a horizontal view path and a semi-transparent display supported on the glasses frame and positioned in the horizontal view path. A projection mechanism is supported on the glasses frame and has a projection lens positioned above the horizontal view path. The projection mechanism is configured for projecting virtual content on the semi-transparent display, with an outer surface of the projection lens facing a rear facing surface of the semi-transparent display. A semi-transparent polarized shield is supported on the glasses frame and is positioned below the horizontal view path, with an inner surface of the semi-transparent polarized shield facing the outer surface of the projection lens. The semi-transparent polarized shield is positioned to filter interfering light passing through the semi-transparent polarized shield and toward the projection lens.

In another aspect, a method of filtering interfering light with a pair of smart glasses includes steps of defining a horizontal view path with a glasses frame, and supporting a semi-transparent display in the horizontal view path with the glasses frame. Virtual content is projected on the semi-transparent display with a projection mechanism supported on the glasses frame and having a projection lens positioned above the horizontal view path. An outer surface of the projection lens faces a rear facing surface of the semi-transparent display. The method also includes supporting a semi-transparent polarized shield below the horizontal view path with the glasses frame, with an inner surface of the semi-transparent polarized shield facing the outer surface of the projection lens. Interfering light passing through the semi-transparent polarized shield and toward the projection lens is filtered with the semi-transparent shield, according to the method.

### BRIEF DESCRIPTION OF THE DRAWINGS

FIG. 1 is a side perspective view of a pair of prior art smart glasses;

FIG. 2 is a pair of smart glasses having interfering light filtering, according to one aspect of the present disclosure;

FIG. 3 is a rear perspective view of the of pair of smart glasses of FIG. 2;

FIG. 4 is a rear perspective view of the pair of smart glasses of the previous FIGS. 2 and 3, shown in an inverted position;

FIG. 5 is a front perspective view of the pair of sunglasses of FIGS. 2-4, shown from a bottom side of the smart glasses;

FIG. 6 is a front view of the smart glasses of the present disclosure;

FIG. 7 is a rear view of the smart glasses of the present disclosure;

FIG. 8 is a right side view of the smart glasses of the present disclosure;

FIG. 9 is a top view of the smart glasses of the present disclosure;

FIG. 10 is a partially exploded view of the smart glasses of the present disclosure, depicted with a semi-transparent polarized shield and a pair of side shields removed from the smart glasses;

FIG. 11 is a front perspective view of the semi-transparent polarized shield and the pair of side shields of FIG. 10, shown in an attached configuration;

FIG. 12 is an exploded front view of the semi-transparent polarized shield and the pair of side shields of the present disclosure, shown in an exploded, or attached, configuration;

FIG. 13 is an exploded, or detached, rear perspective view of the semi-transparent polarized shield and the pair of side shields of the present disclosure;

FIG. 14 is a simplified diagram, depicting an idea travel of an image passing from a projector of the smart glasses to the semi-transparent display, and then bouncing off the semi-transparent display to the user's eye; and

FIG. 15 is a simplified diagram similar to that of FIG. 14, but also depicting interfering light passing through the semi-transparent lens as described herein.

### DETAILED DESCRIPTION

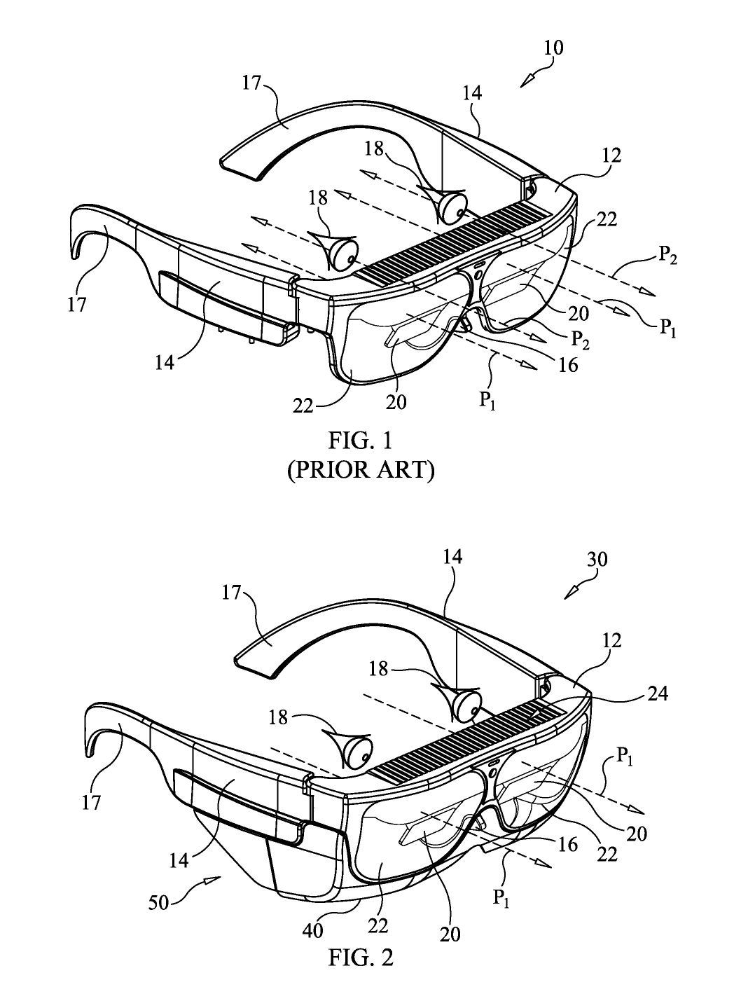

According to an exemplary prior art pair of smart glasses 10, shown in FIG. 1 and labeled PRIOR ART, the smart glasses 10, which may have a variety of configurations and uses, generally include a frame 12 with two side arms 14. However, other configurations, which may or may not include one or both of the frame 12 and the side arms 14, are also prevalent in the industry. Smart glasses, such as smart glasses 10, are known in the art and have various uses, including uses for augmented reality and virtual reality vision. These various uses and configurations may alter the structure and configuration of the smart glasses to which they apply.

According to the exemplary pair of prior art smart glasses 10, as with most pairs of glasses or smart glasses, a horizontal view path P₁ is defined substantially by, and is relatively horizontal relative to, the glasses frame 12, with the smart glasses 10 oriented generally as depicted. It should be appreciated that the exemplary smart glasses 10 are oriented such a nose piece 16 and ear pieces 17 and/or other supports assist in orienting the smart glasses 10 at an appropriate place on the wearer's face such that the wearer's eyes 18 generally have a view path P₂, or paths, through the smart glasses 10 along, or parallel to, the horizontal view path P₁. It should be appreciate that the horizontal view path P₁ may lie in a horizontal plane. According to the illustrated view, the orientation of the smart glasses 10 and, thus, the horizontal view path P₁ may, for example, be substantially horizontal or parallel relative to the ground, depending on the wearer's orientation when wearing the smart glasses 10.

As shown, the glasses frame 12 may directly or indirectly support a pair of stereoscopic see-thru displays, also referred to as semi-transparent displays herein, 20 in the horizontal view path P₁. That is, the semi-transparent displays 20 are positioned within the horizontal view path P₁ such that the wearer's eyes 18 generally have a view path P₂ through the semi-transparent displays 20. The glasses frame 12 may also support a pair of swappable lenses, such as photochromic, clear, or tinted lenses 22, which help protect the stereoscopic see-thru displays 20 from the environment and aid the wearer in various ways. However, other types of lenses 22 are known and may be supported by the glasses frame 12. It should be appreciated that the wearer's eyes 18 may have a view path P₂ sequentially through both the semi-transparent displays 20 and the lenses 22.

The smart glasses 10 may also include a processor, such as, for example, a Snapdragon™ quad-core processor 24. The Snapdragon™ processor 24 may be supplied by Qualcomm®, headquartered in California, 24, and may be somewhat embedded or enclosed within a top portion 26 of the glasses frame 12. Various additional and/or alternative controls or devices, including a camera, sensors, control buttons, Bluetooth and a trackpad, to name a few, may also be supported on, or interactive with components of, the glasses frame 12. The exemplary smart glasses 10 may, for example, be those manufactured by Osterhout Design Group of California and sold under the trade name of R-7 Smartglasses. However, the present disclosure is applicable to a variety of other smart glasses.

Turning now to FIG. 2, an exemplary pair of smart glasses of the present disclosure is shown at 30. Since the present disclosure involves an improvement and/or addition to exemplary prior art smart glasses, such as those shown in FIG.1, some of the reference numerals used with respect to components of the pair of smart glasses 10 of FIG. 1 will be used throughout the specification for like or similar components. So, to reiterate, the smart glasses 30 of the present disclosure may include a glasses frame 12 defining a horizontal view axis P₁ or path(s), along which the wearer, or user, may view or visualize objects, with the wearer's eyes 18, through the semi-transparent displays 20 and, according to the exemplary embodiment, subsequently through the lenses 22.

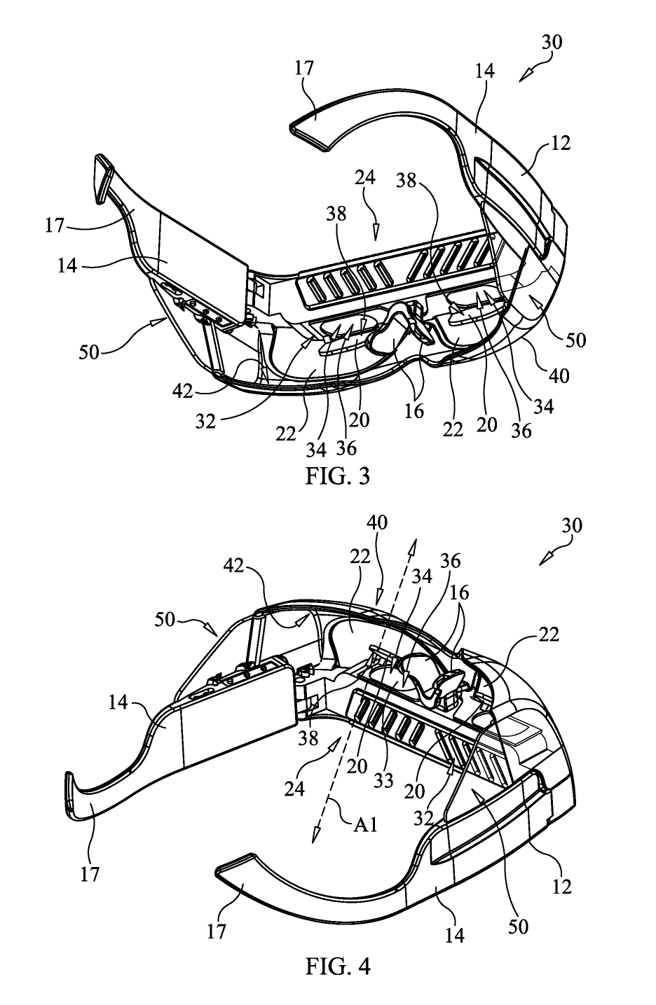

Turning now to FIG. 3, a projection mechanism 32, (present in the previous FIGS. but not clearly visible), which may be widely available for these applications, may be supported on the glasses frame 12, directly or indirectly, and may have a projection lens 34, as a part of or separate from the projection mechanism 32, positioned above the horizontal view path P₁. As is known by those skilled in the art, the projection mechanism 32 may be configured for projecting virtual content on the semi-transparent display(s) 20.

The smart glasses 30, utilizing the projection mechanism 32, may include the capability of running self-contained applications. Alternatively or additionally, the projection mechanism 32 and/or a control device, may communicate with or receive information from the Internet. Such applications and/or information may cause the projection mechanism 32 to project virtual content or information on the semi-transparent display(s) 20, which may be reflected by the semi-transparent display(s) toward the wearer's eyes 18. Further, the smart glasses 30 may operate using voice commands or touch buttons.

To facilitate the operation described above, and according to the present configuration, an outer surface, or surfaces, 36 of the one or more projection lenses 34 of the projection mechanism 32 may face a rear, or back, facing surface, or surfaces, 38 of the semi-transparent display(s) 20. According to some embodiments, the semi-transparent display(s) 20 may be oriented at a 45 degree angle relative to the horizontal view path P₁. However, alternative orientations and configurations are contemplated.

Referring both to FIGS. 3 and 4, and as will be discussed in greater detail below, a semi-transparent polarized shield 40 may be supported, directly or indirectly, using a variety of different attachment means, on the glasses frame 12 and may be positioned below the horizontal view path(s) P₁. That is, if the horizontal view path(s) P₁ is relatively aligned with the horizon, the semi-transparent polarized shield 40 is positioned generally below, rather than above, the horizontal view path(s) P₁.

As is shown in FIG. 4 (which includes an inverted view of the smart glasses 30), the semi-transparent display(s) 20 may be positioned axially (i.e., along a common axis A₁) between the projection lens or lenses 34 and the semi-transparent polarized shield 40. Further, an inner surface or surfaces 42 of the semi-transparent polarized shield 40 may face the outer surface(s) 36 of the projection lens or lenses 34. According to the present disclosure, the semi-transparent polarized shield 40 is positioned to filter interfering light passing through the semi-transparent polarized shield 40 and toward the projection lens or lenses 34.

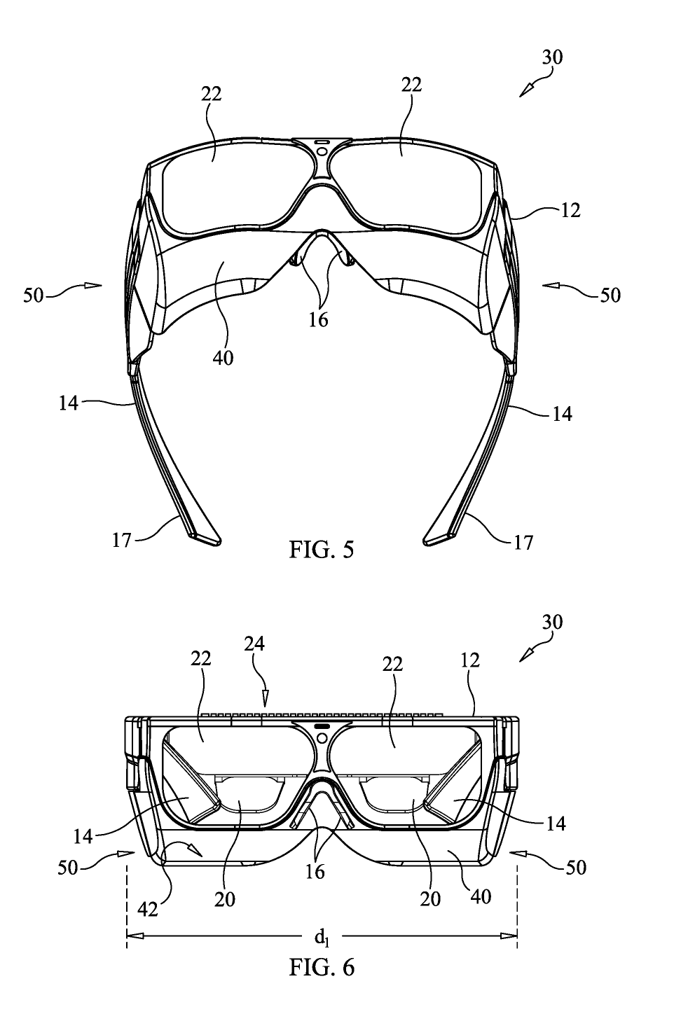

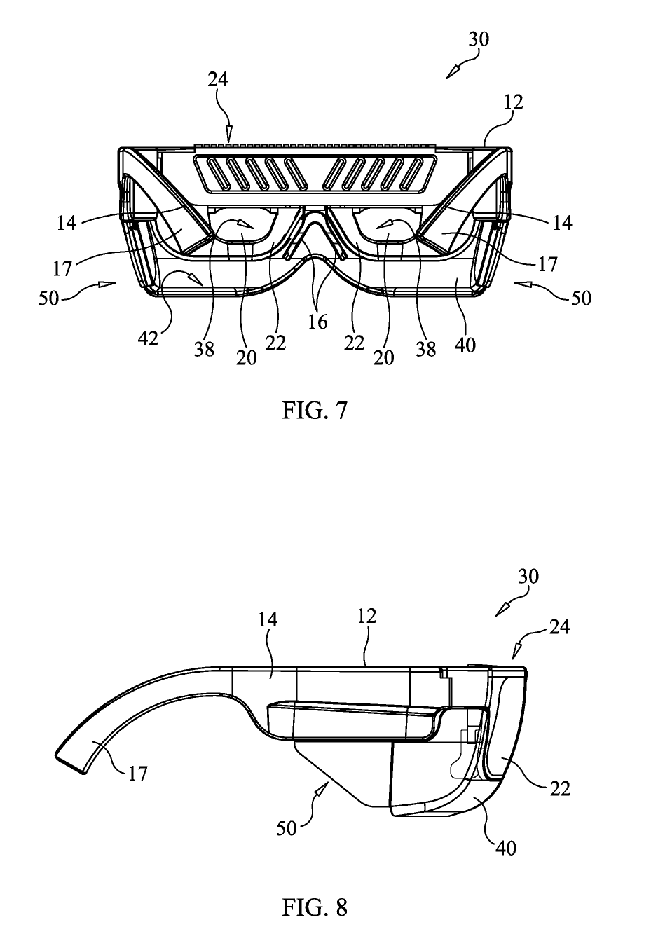

Referring generally to FIGS. 2-7, the semi-transparent polarized shield 40 may be supported on the glasses frame 12 using numerous fastening or attachment means, whether removable, semi-permanent or permanent. According to some embodiments, the semi-transparent polarized shield 40 may be magnetically attached to or supported by the glasses frame 12, such as, for example, by the nose piece (16) and/or side arms 14. The semi-transparent polarized shield 40 may be made from any suitable material and may be configured and positioned to filter interfering art, as described above. Further, the semi-transparent polarized shield 40 may be a unitary structure or may include multiple pieces fastened together.

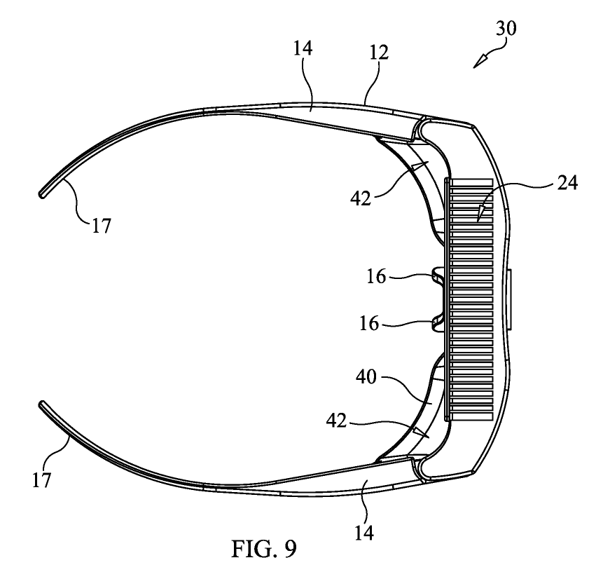

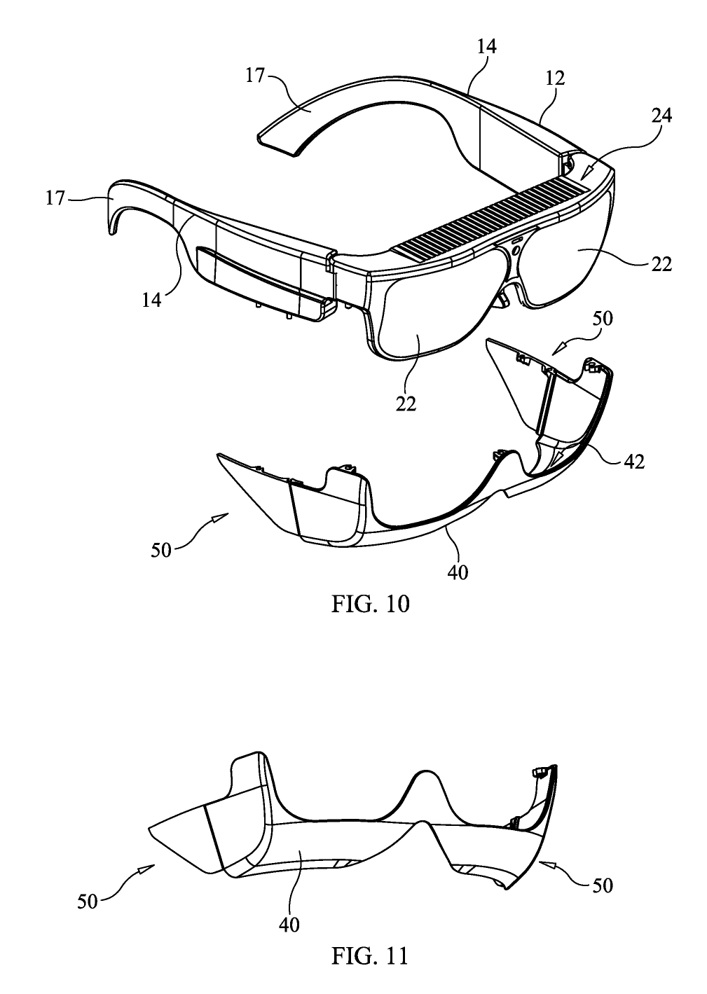

Referring to FIGS. 2-13, the smart glasses 30 of the present disclosure may also include a pair of lens shields 50. Referring specifically to FIG. 4, the pair of lens shields 50 may be supported on the glasses frame 12 and positioned subsequent to the stereoscopic semi-transparent display(s) 20 along the horizontal view path(s) P₁. According to the exemplary embodiment, the lens shields 50 may extend below the side arms 14 and may be substantially parallel to the horizontal view path P₁. The lens shields 50 may be made from a variety of suitable materials and may be sized, configured and positioned to shield inner components of the smart glasses 30, such as the projection mechanism 32 and stereoscopic semi-transparent display(s) 20, from external debris. Further, the lens shields 50 may be polarized to filter interfering light.

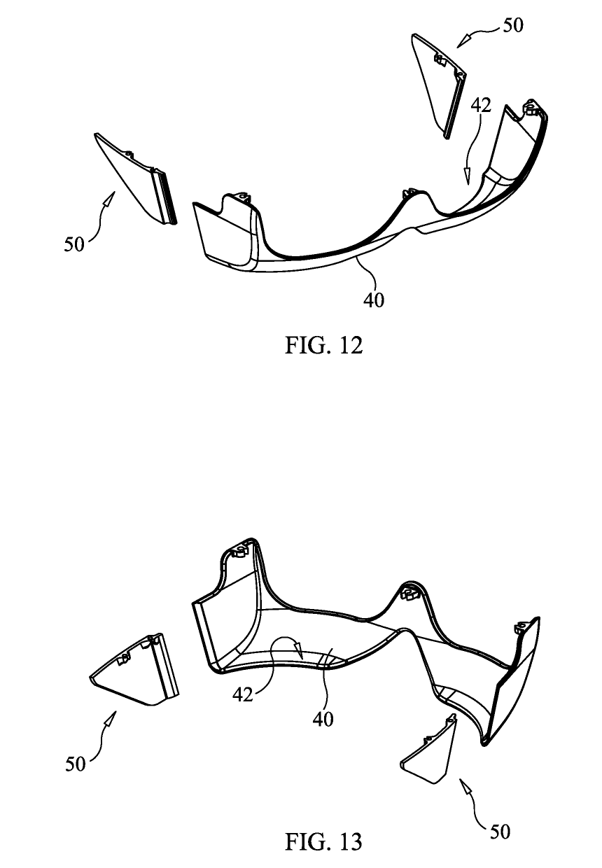

As shown, particularly in FIGS. 8 and 11, the semi-transparent polarized shield 40 may be positioned at least partially below the lens shields 50. According to some embodiments, each of the lens shields 50 has an attachment to the semi-transparent polarized shield 40, with the semi-transparent polarized shield 40 spanning horizontal distance d₁ that includes both of the lens shields 50, as shown in FIG. 6. FIGS. 11-13 depict various views of the semi-transparent polarized shield 40 and lens shields 50, in attached (FIG. 11) and detached configurations (FIGS. 12 and 13).

### INDUSTRIAL APPLICABILITY

The present disclosure relates generally to a broad range of smart glasses. More particularly, the present disclosure is applicable to smart glasses susceptible to interfering light. Further, the present disclosure may find particular applicability to those smart glasses having specific configurations permitting interfering light from entering from below the glasses frame.

Referring generally to FIGS. 1-15, the smart glasses according to the present disclosure generally include a glasses frame defining a horizontal view path. A semi-transparent display is supported on the glasses frame and positioned in the horizontal view path. A projection mechanism is supported on the glasses frame and has a projection lens positioned above the horizontal view path, with the projection mechanism configured for projecting virtual content on the semi-transparent display, and an outer surface of the projection lens facing a rear facing surface of the semi-transparent display. A semi-transparent polarized shield is supported on the glasses frame and positioned below the horizontal view path, with an inner surface of the semi-transparent polarized shield facing the outer surface of the projection lens. The semi-transparent polarized shield is positioned to filter interfering light passing through the semi-transparent polarized shield and toward the projection lens.

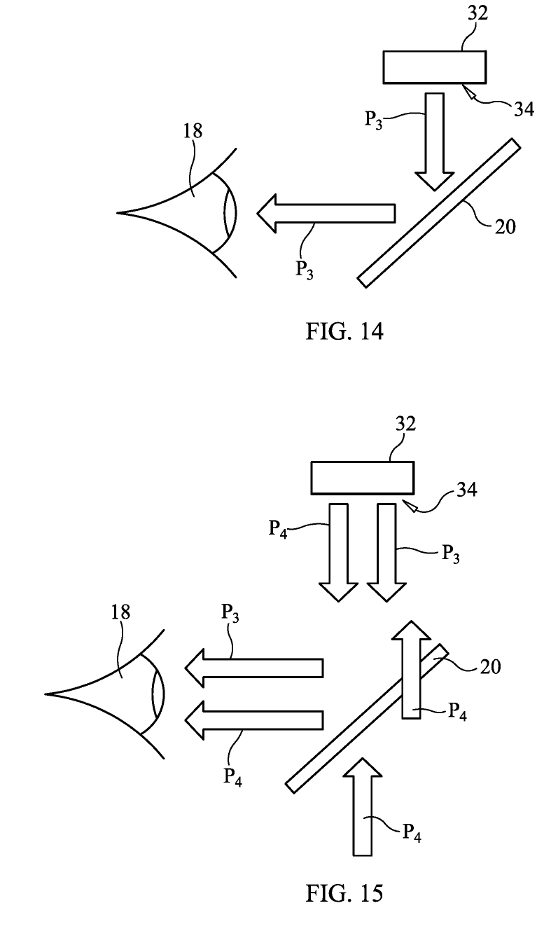

FIG. 14—depicting an idea travel of an image passing from a projector of the smart glasses to the semi-transparent display, and then bouncing off the semi-transparent display to the user's eye.

FIG. 15 is a simplified diagram similar to that of FIG. 14, but also depicting interfering light passing through the semi-transparent lens as described herein.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A pair of smart glasses having interfering light filtering, including:
a glasses frame defining a horizontal view path;
a semi-transparent display supported on the glasses frame and positioned in the horizontal view path;
a projection mechanism supported on the glasses frame and having a projection lens positioned above the horizontal view path, the projection mechanism configured for projecting virtual content on the semi-transparent display, an outer surface of the projection lens facing a rear facing surface of the semi-transparent display; and
a semi-transparent polarized shield supported on the glasses frame and positioned below the horizontal view path, an inner surface of the semi-transparent polarized shield facing the outer surface of the projection lens, the semi-transparent polarized shield positioned to filter interfering light passing through the semi-transparent polarized shield and toward the projection lens.

2. The pair of smart glasses of claim 1, wherein the semi-transparent display is positioned axially between the projection lens and the semi-transparent polarized shield.

3. The pair of smart glasses of claim 2, wherein the semi-transparent display is oriented at a 45 degree angle relative to the horizontal view path.

4. The pair of smart glasses of claim 1, wherein the glasses frame supports a pair of stereoscopic semi-transparent displays positioned in the horizontal view path.

5. The pair of smart glasses of claim 4, further including a pair of lens shields supported on the frame and positioned subsequent to the stereoscopic semi-transparent displays along the horizontal view path, where the lens shields are substantially parallel to the horizontal view path.

6. The pair of smart glasses of claim 5, wherein the semi-transparent polarized shield is positioned at least partially below the lens shields.

7. The pair of smart glasses of claim 6, wherein the semi-transparent polarized shield spans a horizontal distance including both of the lens shields.

8. The pair of smart glasses of claim 7, wherein the frame includes a front and two side arms, wherein the pair of smart glasses further includes a pair of side shields, wherein each of the side shields extends below one of the side arms.

9. The pair of smart glasses of claim 8, wherein each of the side shields has an attachment to the semi-transparent polarized shield.

10. The pair of smart glasses of claim 9, wherein each of the side shields is polarized.

11. The pair of smart glasses of claim 1, wherein the glasses frame includes a front and two side arms, wherein the pair of smart glasses further includes at least one side shield extending below one of the side arms.

12. The pair of smart glasses of claim 11, wherein the at least one side shield is polarized.

13. The pair of smart glasses of claim 12, wherein the at least one side shield has an attachment to the semi-transparent polarized shield.

14. A method of filtering interfering light with a pair of smart glasses, the method including steps of:
defining a horizontal view path with a glasses frame;
supporting a semi-transparent display in the horizontal view path with the glasses frame;
projecting virtual content on the semi-transparent display with a projection mechanism supported on the glasses frame and having a projection lens positioned above the horizontal view path, wherein an outer surface of the projection lens faces a rear facing surface of the semi-transparent display;
supporting a semi-transparent polarized shield below the horizontal view path with the glasses frame, wherein an inner surface of the semi-transparent polarized shield faces the outer surface of the projection lens; and
filtering interfering light passing through the semi-transparent polarized shield and toward the projection lens with the semi-transparent polarized shield.

15. The method of claim 14, further including orienting the semi-transparent display at a 45 degree angle relative to the horizontal view path.

16. The method of claim 14, further including shielding a pair of stereoscopic semi-transparent displays with a pair of lens shields supported on the frame, and supporting the semi-transparent polarized shield at least partially below the lens shields.

17. The method of claim 16, further including attaching the semi-transparent polarized shield to the lens shields with a magnetic attachment.

18. The method of claim 16, further including shielding the pair of stereoscopic semi-transparent displays with a pair of side shields, each of the side shields extending below one of a pair of side arms of the glasses frame.

19. The method of claim 18, further including filtering interfering light with a pair of polarized side shields.

20. The method of claim 18, further including attaching the side shields to the semi-transparent polarized shield.
